(19) United States
(12) Patent Application Publication
(10) Pub. No.: US 2026/0244997 A1
(43) Pub. Date: Aug. 20, 2026

(54) META-MODEL FRAMEWORK FOR SIMULTANEOUS DUAL SCENARIO PREDICTION

(71) Applicant: MedeAnalytics, Inc., Richardson, TX (US)

(72) Inventors: Matthew HANAUER, Durham, NC (US); David SCHWEPPE, Walnut Creek, CA (US); David WOLF, Atlanta, GA (US); Robert CORRIGAN, Riverside, IL (US)

(73) Assignee: MedeAnalytics, Inc., Richardson, TX (US)

(21) Appl. No.: 19/539,586

(22) Filed: Feb. 13, 2026

Related U.S. Application Data
(60) Provisional application No. 63/803,118, filed on May 9, 2025.
(60) Provisional application No. 63/758,568, filed on Feb. 14, 2025.

(51) Int. Cl. G06N 20/20

(52) U.S. Cl. CPC G06N 20/20

(57) ABSTRACT

Embodiments relate to technological systems and methods for determining return on investment (ROI) of a program (e.g., medical intervention), which may be used to retrospectively or prospectively evaluate the value that the program delivered or will deliver to a patient (e.g., a participant in a program). In some embodiments, a first set of training data associated with a patient population is retrieved. The training data may be classified as belonging to a patient treatment group including patients participating in a program or a patient control group including patients not participating in the program. A plurality of base machine learning models may be trained using a dual-training process to generate both counterfactual values and ROI predictions associated with patients. A global machine learning model may then be trained on the counterfactual values and ROI predictions output by the base machine learning models.

### CROSS REFERENCE TO RELATED APPLICATIONS

This application claims the benefit of U.S. Provisional Application No. 63/803,118, filed May 9, 2025, titled “PROGRAM EVALUATION, INTERVENTION PREDICTION, AND RETURN ON INVESTMENT MODEL,” and U.S. Provisional Application No. 63/758,568, filed February 14, 2025, titled “PROGRAM EVALUATION AND RETURN ON INVESTMENT MODEL,” each of which is hereby incorporated herein by reference in its entirety.

### BRIEF SUMMARY

Healthcare companies offering healthcare products or services often want to know whether they are receiving or will receive a return on investment (ROI). At a high level, ROI is a ratio of benefits to costs. ROI is typically presented as a percentage (e.g., 700%) or a numerical scaling factor (e.g., 7x ROI). However, calculating ROI is often overly simplistic, failing to account for factors such as: (1) what would have happened in the absence of the product (e.g., a specific healthcare program); (2) forecasts of outcomes that will occur if a patient participates in a program versus if the patient does not participate; (3) which benefits can be specifically attributed to the product (e.g., program); and (4) correlation between received or predicted benefits. Current systems for calculating ROI are also frequently inaccurate and fail to take advantage of robust modeling techniques. Introducing the combination of these factors and improved stacking methods into ROI, among other things, provides significantly more accurate and useful ROI estimates and forecasts, as well as creates the ability to determine both retrospective and prospective ROI. Moreover, by simultaneously modeling both potential future scenarios—with program participation and without program participation—organizations can better predict the incremental value a program will deliver before implementation. This dual-path prediction approach enables more informed decision-making by quantifying the specific impact attributable to the program itself, rather than changes that would have occurred naturally. For example, an ROI forecast may indicate that a patient is predicted to save $200 by participating in a program compared to their projected costs without the program.

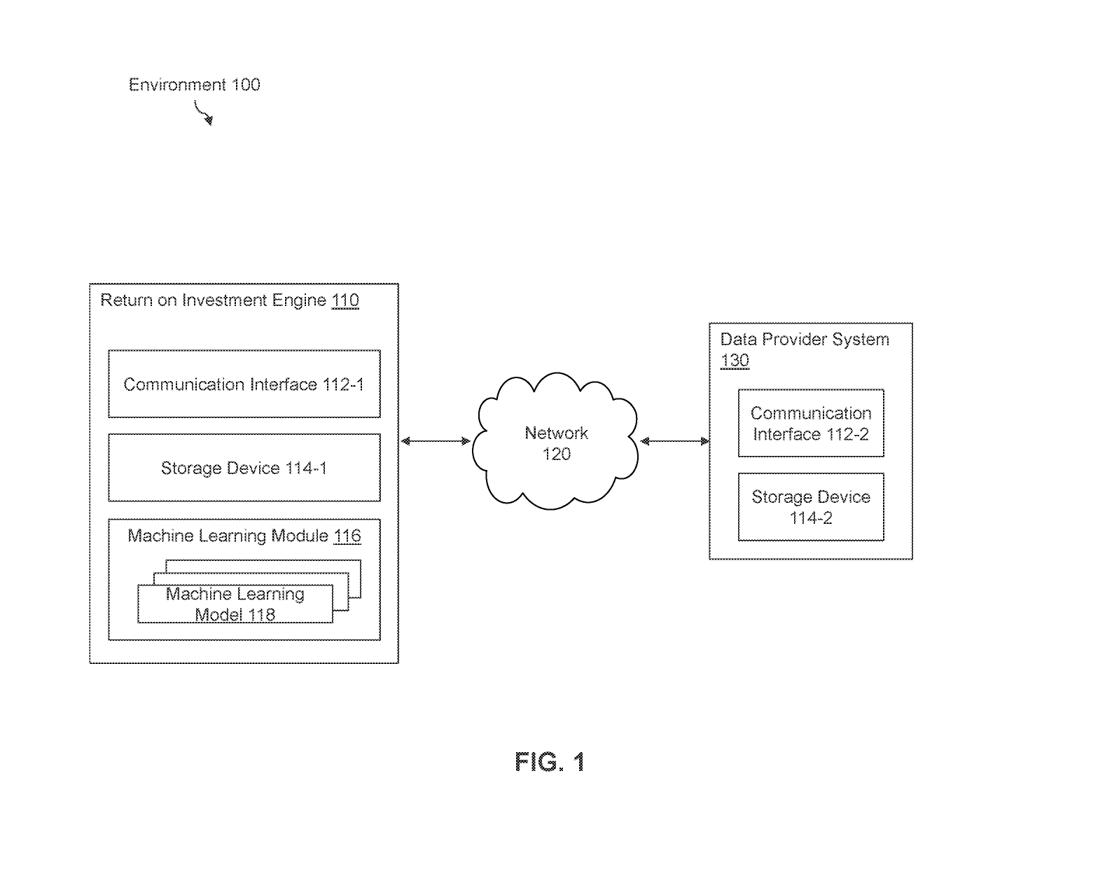

FIG. 1 depicts an exemplary environment for calculating return on investment, according to some embodiments.

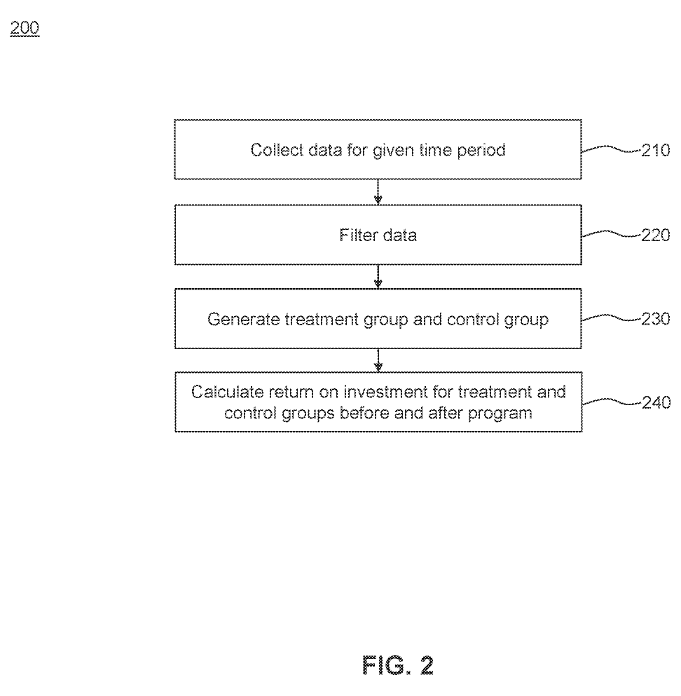

FIG. 2 is a flowchart illustrating an example process for calculating return on investment, according to some embodiments.

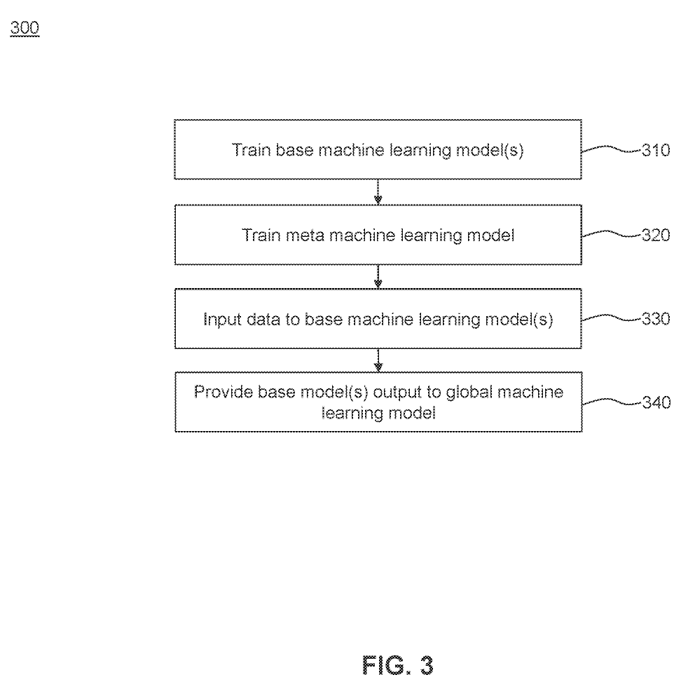

FIG. 3 is a flowchart illustrating an example process of using one or more machine learning models for calculating return on investment, according to some embodiments.

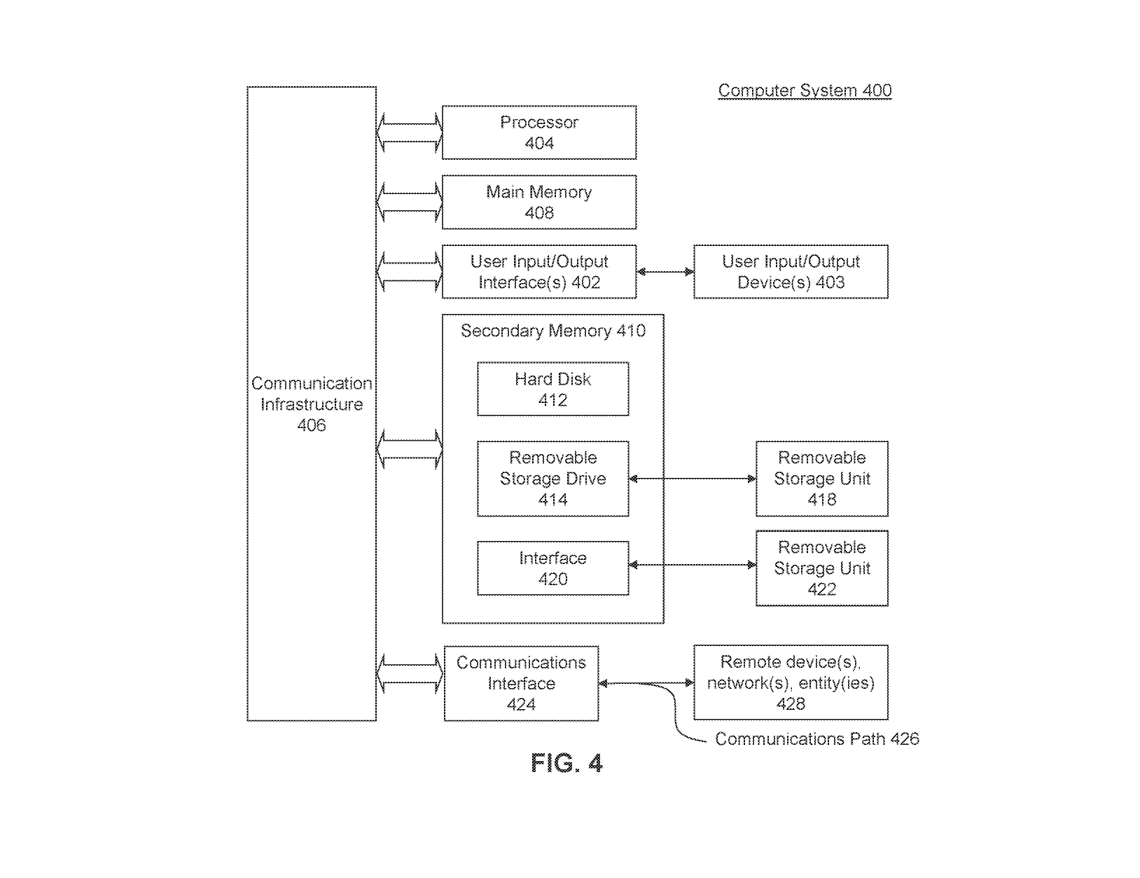

FIG. 4 depicts an example computer system useful for implementing various embodiments.

### DETAILED DESCRIPTION

In some embodiments, the present invention provides technological systems and methods for determining ROI of a program (e.g., medical intervention), which may be used to retrospectively or prospectively evaluate the value that the program delivered or will deliver to a patient (e.g., a participant in a program). Some embodiments involve training and use of a machine learning model to determine ROI. In some embodiments, a dual-path approach is employed involving training and use of machine learning models to simultaneously determine potential outcomes both with program participation and without program participation. In some embodiments, multiple machine learning models may be trained and used to determine ROI, for example through this dual-path approach. For example, one or more base models may be trained to predict an estimated cost for a given patient, with or without program participation. The output of the one or more base models may be input to a global model. The global model may be trained to weight (e.g., bias) the output of the one or more base models to predict final costs in both scenarios, allowing for calculation of the incremental value specifically attributable to the program.

As opposed to current systems that may use spreadsheet applications to determine an ROI, using machine learning in the manner described throughout this disclosure allows for rapid and accurate ROI determination. For example, current approaches to ROI determination are complex, resource-intensive, time consuming, and often require frequent manual inputs. Given these shortcomings, these systems often encounter frequent errors that require further manual input to correct them. Systems and methods described herein utilize machine learning models, such as x-learners that allow for granular insights into the effectiveness of a program. For example, current methods may be unable to determine that different members may have different responses to the same program. In contrast, x-learners are able to detect differences between members, in order to determine which members or class of members would benefit the most from a specific program.

As noted above, in some embodiments, the output of the one or more base models may be input to a global model to determine the ROI of a program. This technique provides enhanced predictive modeling through hierarchical model stacking. By using a multi-layer architecture where the base model output is provided to a global model, the technique improves upon traditional ensemble methods. Systems and methods disclosed leverage a meta-learning framework where multiple base models, each specializing in a distinct pattern recognition task, are systematically combined through a sophisticated global model (e.g., meta-model). This global model represents a significant improvement over conventional ensemble approaches, which typically rely on fixed combination rules, such as averaging or voting.

The multi-layer architecture incorporates base models selected for their complementary pattern recognition capabilities, including but not limited to: gradient boosted machines optimized for complex non-linear feature interactions, neural networks architected for temporal and sequential pattern detection, and linear models providing robust baseline predictions for straightforward relationship mapping. The global model layer may be designed to dynamically learn optimal combination weights for one or more base model predictions, adapting its weighting scheme based on the specific characteristics of each base model.

The multi-layer architecture further includes a feature-aware integration mechanism. Unlike traditional ensembles that operate solely on model predictions, the global model simultaneously processes both the original feature set and a base model prediction. In some embodiments, the global model may simultaneously process the original feature set and a plurality of base model predictions. This dual-input architecture enables the global model to learn sophisticated contextual rules governing the reliability and applicability of each base model prediction under varying conditions. The global model effectively recognizes situations where specific types of pattern recognition become particularly relevant, allowing for more nuanced and accurate predictions than would be possible with conventional ensemble methods or single-model approaches.

The multi-layer architecture may be used in complex prediction tasks, such as ROI prediction, where different subsets of cases may benefit from different types of pattern recognition. For example, in medical readmission prediction, the system can automatically adjust its reliance on different base models depending on patient characteristics, temporal patterns, and feature interactions. This adaptive behavior enables the system to maintain high prediction accuracy across a diverse range of cases, effectively leveraging the strongest aspects of each component (e.g., base) model while mitigating their individual weaknesses.

The disclosure further includes methods for training the global model to optimize its combination strategies, including techniques for preventing overfitting and ensuring robust generalization to new data. The system includes mechanisms for monitoring and analyzing the relative contributions of different base models, providing insights into pattern recognition dynamics across varying input conditions. For example, the global model may learn, given the configuration of a base model, that the base model predicts an ROI greater than a predefined threshold when input patient data includes a certain characteristic. As a result, the global model may learn to weight (e.g., shrink) the output of the base model to account for the outlier.

In some embodiments, a method and system for enhanced predictive modeling through hierarchical model stacking is provided, comprising a multi-layer architecture that fundamentally advances beyond traditional ensemble methods. The invention leverages a meta-learning framework wherein multiple base models, each specialized in distinct pattern recognition tasks, are systematically combined through a sophisticated meta-model layer. This meta-model structure enables simultaneous prediction of dual scenarios—with and without program participation—providing a more accurate assessment of the incremental value attributable to the program itself. This approach represents a significant improvement over conventional ensemble approaches, which typically rely on fixed combination rules such as averaging or voting. The system's innovative architecture incorporates base models selected for their complementary pattern recognition capabilities, including but not limited to: gradient boosted machines optimized for complex non-linear feature interactions, neural networks specifically architected for temporal and sequential pattern detection, and linear models providing robust baseline predictions for straightforward relationship mapping. The meta-model layer is designed to dynamically learn optimal combination weights for these base models' predictions, adapting its weighting scheme based on the specific characteristics of each input case.

In such embodiments, a key advancement of the invention lies in its feature-aware integration mechanism. Unlike traditional ensembles that operate solely on model predictions, the meta-model layer simultaneously processes both the original feature set and the base models' predictions. This dual-input architecture enables the system to learn sophisticated contextual rules governing the reliability and applicability of each base model’s predictions under varying conditions. The meta-model can effectively recognize situations where specific types of pattern recognition become particularly relevant, allowing for more nuanced and accurate predictions than would be possible with conventional ensemble methods or single-model approaches.

Such embodiments, like those described above, demonstrate particular utility in complex prediction tasks where different subsets of cases may benefit from different types of pattern recognition. For example, in medical readmission prediction, the system can automatically adjust its reliance on different base models depending on patient characteristics, temporal patterns, and feature interactions. This adaptive behavior enables the system to maintain high prediction accuracy across a diverse range of cases, effectively leveraging the strongest aspects of each component model while mitigating their individual weaknesses.

In some embodiments, the invention further comprises methods for training the meta-model layer to optimize its combination strategies, including techniques for preventing overfitting and ensuring robust generalization to new cases. The system includes mechanisms for monitoring and analyzing the relative contributions of different base models, providing insights into pattern recognition dynamics across varying input conditions.

In some embodiments, determining the ROI for a given program (e.g., prescription drug regimen, surgery, and diet) may include determining the cost of a counterfactual scenario where the individual did not participate in the program. In some embodiments, determining the ROI for a given program (e.g., prescription drug regimen, surgery, and diet) includes simultaneously predicting outcomes in two scenarios: one where the individual participates in the program and another where they do not. As noted above, when determining ROI it is beneficial to understand the benefits specifically attributable to the program. For example, a patient prescribed a diabetes medication may be predicted to have reduced monthly healthcare costs. However, it is possible that only some of the reduction would be attributable to the prescribed medication. The reduction may be partially attributable to other factors such as lifestyle changes (e.g., diet, exercise) or other programs (e.g., other prescribed medications, surgery). Determining an accurate ROI requires determining or predicting the savings specifically attributable to the program in question. As a result, in some embodiments, calculating an ROI of a counterfactual where the patient does not take part in the program (e.g., does not receive the diabetes medication), and subtracting that from the initial ROI calculation allows a more accurate ROI to be determined because it focuses on the effect of the program. Alternatively, in some embodiments, simultaneously modeling both scenarios—with and without program participation—allows for a more accurate ROI to be determined because it focuses on the incremental effect of the program.

In some embodiments, the systems and methods described herein may be used to prospectively determine the ROI of a program. Determining a prospective ROI may involve analysis of historical performance data, identifying key patterns, trends, and seasonal variations that may impact results. Noted above, one or more machine learning models may be trained using this historical data, incorporating relevant variables such as market conditions, vendor performance metrics, and time-based factors. To predict prospective ROI, current features (e.g., age, gender, chronic conditions) are combined with growth rates and/or decline rates learned by the machine learning model. In some embodiments, known future changes such as contract modifications or pricing adjustments may also be taken into account. In some embodiments, multiple prospective ROIs may be determined for various growth rate scenarios. Scenarios may be categorized as conservative, moderate, and aggressive.

In some embodiments, the systems and methods described herein may be designed to prospectively determine the ROI of a program before implementation. Determining a prospective ROI may involve analysis of historical performance data, identifying key patterns, trends, and seasonal variations that may impact results. As noted above, multiple machine learning models may be trained using this historical data, incorporating relevant variables such as patient characteristics, market conditions, vendor performance metrics, and time-based factors. To predict prospective ROI, current features (e.g., age, gender, chronic conditions) are combined with growth rates and/or decline rates learned by the machine learning models to simultaneously forecast outcomes in both scenarios - with program participation and without program participation. The difference between these two forecasts represents the incremental value attributable to the program. In some embodiments, known future changes such as contract modifications or pricing adjustments may also be taken into account. In some embodiments, multiple prospective ROI scenarios may be determined for various growth rate projections, categorized as conservative, moderate, and aggressive.

Growth rates may be determined by establishing base rates through analysis of current features metrics, calculating average historical growth rates, identifying recurring patterns, and segmenting growth rates by categories. Various rate adjustment factors may then be considered, including market conditions (e.g., decreasing chronic conditions), economic indicators (e.g., increasing medical paid), and regulatory changes (e.g., changes in payments). The implementation phase may involve applying compound growth formulas, using weighted averages, factoring in diminishing returns, and accounting for capacity constraints. Scenario development may involve creating conservative, moderate, and aggressive scenarios, each using different growth rate assumptions and risk-adjusted scenarios. A validation process may be performed including back-testing against historical data, peer comparison benchmarking, reality checks on projections, and sensitivity analysis. Ongoing maintenance may be performed to ensure accurate projections, involving regular rate recalibration, updating assumptions, tracking projection variance, and adjusting for changing conditions.

As an example, consider a population where the average allowed amount is $5,000 per member per year (PMPY), medical paid amounts average $4,200 PMPY, and 35% of members have chronic conditions. Historical analysis might show that allowed amounts typically increase by 6% annually due to medical inflation and utilization patterns, while medical paid amounts grow at 5.5% due to improved network management. The prevalence of chronic conditions tends to increase by 2% annually in an aging population. Applying these growth rates, after one year, the projected allowed amount would reach $5,300 PMPY ($5,000 x 1.06), medical paid amounts would grow to $4,431 PMPY ($4,200 x 1.055), and chronic condition prevalence would increase to 35.7% (35% x 1.02). In some embodiments, rates may be further adjusted based on risk factors. For instance, members with multiple chronic conditions might see allowed amounts growing at 8% instead of 6%, while younger, healthier cohorts might experience only 4% growth. Growth rate determination may also account for program impacts, such as disease management programs that could slow the growth rate of chronic conditions or care management initiatives that might reduce the medical paid growth rate to 4% for engaged members.

FIG. 1 depicts an exemplary environment 100 for calculating return on investment, according to some embodiments. Environment 100 includes return on investment (ROI) engine 110, network 120, and data provider system 130.

Network 120 may be any type of computer or telecommunications network capable of communicating data, for example, a local area network, a wide-area network (e.g., the Internet), or any combination thereof. The network may include wired and/or wireless segments.

ROI engine 110 may be configured to determine the ROI of a program. ROI engine 110 includes communication interface 112-1, storage device 114, and machine learning module 116.

Communication interface 112-1 may be configured to communicate entities on network 120, such as data provider system 130. Communication interface 112-1 may comprise any suitable network interface capable of transmitting and receiving data, such as, for example a modem, an Ethernet card, a communications port, or the like. Communication interface 112-1 may be able to transmit data using any wireless transmission standard such as, for example, Wi-Fi, Bluetooth, cellular, or any other suitable wireless transmission.

Storage device 114 may be any memory storage device. Storage device 114 may be organized as a database, such as a SQL database. Storage device 114 may be used to store data for calculating an ROI. For example, storage device 114 may be configured to store: (1) enrollment data; (2) claim data; (3) healthcare effectiveness data and information set (HEDIS) metrics; (4) adjusted clinical group risk scores; and (5) custom metrics. An adjusted clinical group (ACG) may be a population health categorization system that measures and predicts healthcare utilization by grouping patients based on their age, gender, and patterns of diagnosed diseases to generate risk scores that reflect their expected healthcare needs and costs. Enrollment data may include patient demographic information as well as information relating the patient’s insurance plan. Claim data may include information relating to insurance claims filed by the patient. Claims may involve medical or pharmaceutical interventions. HEDIS metrics may include measurements of various types of health care. Custom metrics may include care management program participation rates, patient portal activation percentage, telehealth utilization rate by condition group, and appointment show rate by provider type. Data at storage device 114-1 may originate from data provider system 130.

Machine learning module 116 may include machine learning model 118. Machine learning module 116 may include multiple of machine learning model 118. Each machine learning model 118 may be trained on different data, have a different architecture, or both. As will be discussed below, machine learning module 116 may receive data from data provider system 130 and leverage machine learning model 118 to generate an ROI.

Data provider system 130 may be any entity capable of generating and/or storing data. For example, data provider system 130 may be a hospital, outpatient clinic, or insurance provider. Data provider system 130 includes communication interface 112-2 and storage device 114-2. Data provider system 130 may communicate with ROI engine 110, via communication interface 112-2, over network 120. Although a single data provider system 130 is depicted, environment 100 may include multiple data provider systems 130.

Data provider system 130 may generate and store data or metrics at storage device 114-2. For example, if data provider system 130 is an insurance provider, storage device 114-2 may include, among others, enrollment data and claim data. Data provider system 130 may automatically send updated data to ROI engine 110. In some embodiments, data provider system 130 may respond to requests from ROI engine 110 for data. For example, ROI engine 110 may perform a “refresh” operation, requesting updated values for tracked data. Data provider system 130 may transmit the updated values over network 120.

In some embodiments, data provider system 130 may provide data to ROI engine 110 in response to one or more SQL queries. Noted above, storage device 114 may be formatted as a relational database. ROI engine 110 may generate SQL queries configured to do the following. (1) attribute claims across time periods: This step may involve mapping healthcare claims to their appropriate measurement periods to ensure costs and services are analyzed within the correct timeframes, particularly important when claims processing dates differ from service dates. (2) Manage enrollment gaps and changes: This may involve accounting for members who have interruptions in coverage or changes in plan types, ensuring continuous periods of eligibility are properly tracked and discontinuous periods are appropriately handled in the analysis. (3) Account for claim adjustments and reversals: This step may include tracking and reconciling any modifications to original claims, including voided claims, payment corrections, or updated diagnosis codes to maintain accurate cost and utilization data. (4) Standardize metrics across different data sources: This may involve normalizing data from various sources (such as medical claims, pharmacy claims, lab results, etc.) into consistent formats and units of measurement to enable accurate comparisons and analysis. (5) Apply appropriate risk adjustments: This step may involve implementing statistical methods to account for differences in population health status, demographics, and other factors that could impact outcomes, ensuring fair comparisons across different member groups. ROI engine 110 may store data retrieved from data provider system 130 at storage device 114-1.

Once data is received, ROI engine 110 may perform a filtering process. The filter process may be configured to identify patients eligible for ROI calculation. The filter process may include: (1) filtering members based on specific program criteria; (2) identifying an earliest eligibility date for each member; (3) applying relevant cutoff dates; and (4) standardizing dates into consistent periods (e.g., quarterly or monthly). This first step ensures only members who meet the defined program requirements (e.g., diagnosis codes, age ranges, or utilization patterns) are included in the analysis, maintaining program integrity and relevance. Establishing each member’s initial eligibility date creates a clear starting point for tracking program participation and outcomes, which may be essential for accurate measurement of program impact over time. Setting appropriate start and end dates for the analysis period helps create clean measurement windows and ensures that members are evaluated within the same timeframe, leading to more reliable comparisons. Converting various dates into uniform measurement periods (e.g., quarters or months) enables systematic analysis and reporting, making it easier to track trends and compare outcomes across different time segments.

ROI engine 110 may then create treatment and control groups. Noted above, determining ROI of a program may involve analyzing data of patients that did not participate in the program. Thus, ROI of the program may be determined with better accuracy. As a result, for a program that ROI engine 110 is configured to determine the ROI of, ROI engine 110 may create a treatment group including patients meeting specific program criteria. ROI engine 110 may further create a control group including patients that did not participate in the program.

ROI engine 110 may then analyze data of both groups before the program at differing time points (e.g., 0-3-months, 3-6 months pre-eligibility start date). For data after the program, ROI engine 110 may: (1) track changes across multiple time intervals; (2) create consistent measurement periods; and (3) account for program ramp-up time.

Machine learning module 116 may be used to predict the ROI. In some embodiments, machine learning module 116 may leverage a single machine learning model 118 to predict the ROI. In some embodiments, machine learning module 116 may comprise multiple machine learning models 118 and leverage ensemble learning to predict the ROI. Ensemble learning may combine the output from multiple machine learning models 118, combine the outputs, and generate a single prediction.

Machine learning model 118 may be trained on patient data to predict the ROI. Specifically, machine learning model 118 may be trained to predict an expected healthcare cost for a patient over a certain period of time. During training, machine learning model 118 may use Bayesian hyperparameter optimization. Machine learning model 118 may use hyperparameters to configure attributes (e.g., characteristics) of the model such as learning rate, batch size, and number of hidden layers. Bayesian hyperparameter optimization may efficiently search the space of hyperparameters in order to identify optimal hyperparameter values that will improve the performance of machine learning model 118. Noted above, machine learning module 116 may include any number of machine learning models 118. For example, machine learning module 116 may include three machine learning models 118: an xgboost model, random forest model, and a linear model such as a light gradient boosting machine (GBM) model. For the xgboost model, Bayesian hyperparameter optimization may optimize learning rate, maximum depth, and a number of estimators. For the random forest model, Bayesian hyperparameter optimization may optimize a number of estimators, maximum depth, and a minimum number of samples per split. For the linear model, Bayesian hyperparameter optimization may optimize regularization parameters.

As opposed to current systems that may use grid search to optimize hyperparameters, Bayesian hyperparameter optimization is: (1) more efficient because hyperparameters are updated to improve model performance, rather than grid search that considers all options, including those that may worsen model performance; (2) learns from previous trials; and (3) handles complex hyperparameter interaction.

Each machine learning model 118 of machine learning module 116 may be trained on patient data. Patient data may include information indicating which programs a patient has participated in. Since each model may have different architecture, they each may learn or emphasize different features within the training data set. For example, an xgboost model may emphasize recent health changes, a random forest model may emphasize patient age and chronic conditions, and a light GBM model may emphasize historic cost patterns. As a result, each model may predict different ROI values for the same program utilized by the same patient.

A machine learning model 118 of machine learning module 116 may be a global machine learning model configured to receive as input the output from one or more other machine learning models 118. For example, the global machine learning model may receive as input the output from the xgboost model, random forest model, and light GBM model. The global machine learning model may be configured to weight and combine the outputs of each model to determine a single ROI value. For example, the xgboost model, random forest model, and light GBM model ROI predictions may respectively be: $145, $155, and $148. The global machine learning model may be configured to weight the xgboost model by 50%, the random forest model by 30%, and the light GBM model by 20%. The global machine learning model may then weight each predicted value and sum them together, resulting in a final ROI of $148.60. By incorporating multiple outputs, the global machine learning model accounts for individual model biases, minimizes the impact of any single model’s weaknesses, and provides more stable and reliable predictions across different types of cases.

Noted above, the ROI may be calculated for a specific program. Thus, machine learning model 118 may be trained to predict the ROI of the specific program. Here, machine learning model 118 may be trained on patient data of patients that did not participate in the program. As a result, a more accurate ROI may be predicted because ROI engine 110 may determine the ROI attributable to the program. For example, a patient may have received a program, and subsequently their monthly medical costs may reduce form $1,000 to $800. However, the $200 reduction may not completely be attributable to the program. Here, machine learning model 118 may be trained on patient data of patients that did not participate in the program. For example, machine learning model 118 may predict a cost reduction of $50, based on a variety of factors. Factors may include natural cost trends (e.g., market price adjustments, seasonal price changes), typical health progression patterns, healthcare utilization patterns, regional cost changes, and demographic factors. As a result, the patient’s savings may be reduced by $50, generating a final savings of $150 attributable to the program.

As a result, ROI engine 110 identifies: (1) the types of patients that benefited the most from certain programs, and (2) how programs may be improved. ROI engine 110 also provides early signal detection. For example, ROI engine 110 may detect: (1) whether certain patients consistently encounter negative ROI for a given program; (2) whether a program’s cost is too high for one or more patient groups; and (3) which patients need additional support to improve ROI. ROI engine 110 also provides for program optimization opportunities. For example, the intensity of a program may be increased or decreased based on calculated ROI. Furthermore, a program may be modified for one or more patient groups. Additionally, patient criteria for a program may be optimized based on ROI patterns detected by ROI engine 110. ROI engine 110 also provides risk and variance analysis. By calculating ROI for a given patient, ROI engine 110 determines: (1) a range of program outcomes, not just an average; (2) consistency of program impact; and (3) likelihood of positive ROI for different patients. ROI engine 110 may be configured to generate one or more reports. For example, ROI engine may generate: (1) ROI distribution curves; (2) patient success stories; and (3) evidence of program value for different patient populations.

FIG. 2 is a flowchart illustrating process 200 for calculating return on investment, according to some embodiments. Process 200 shall be described with reference to FIG. 1. However, process 200 is not limited to that example embodiment.

Process 200 may be executed on any computing device, such as, for example, the exemplary computer system described with reference to FIG. 4. Process 200 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 2 may be omitted, repeated, performed simultaneously, and/or performed in a different order than the order shown in FIG. 2. Accordingly, the scope of the invention should not be considered limited to the specific arrangement of steps shown in FIG. 2. The steps shown in FIG. 2 may be implemented as computer-readable instructions stored on computer-readable media, where, when the instructions are executed, cause a processor to perform the process of FIG. 2.

At 210, ROI engine 110 collects for a given time period. The data may include (1) enrollment data; (2) claim data; (3) healthcare effectiveness data and information set (HEDIS) metrics; (4) adjusted clinical group risk scores; and (5) custom metrics. ROI engine 110 may retrieve the data from data provider system 130.

At 220, ROI engine 110 filters the collected data. Filtering may be configured to identify patients eligible for ROI calculation. The filter process may include: (1) filtering members based on specific program criteria; (2) identifying an earliest activity date for each member; (3) applying relevant cutoff dates; and (4) standardizing dates into consistent periods (e.g., quarterly or monthly).

At 230, ROI engine 110 creates a treatment group and a control group. The treatment group may include one or more patients that participated in a program. The control group may include one or more patients that did not participate in the program.

At 240, ROI engine 110 calculates a return on investment for treatment and control groups before and after participation in a program. ROI engine 110 may use machine learning module 116 to calculate the ROI for the treatment and control groups. Noted above, machine learning module 116 may include any number of machine learning models 118. For example, machine learning module 116 may include three base machine learning models 118: (1) an xgboost model; (2) a random forest model; and (3) a light GBM model. Each of these base machine learning models 118 may be trained to predict an ROI or savings value for a patient that did not participate in the program. Machine learning module 116 may further include a global machine learning model 118, configured to weight and combine the output from each base machine learning model 118 into a single value (e.g., a counterfactual value). ROI engine 110 may then subtract the counterfactual value from an ROI generated for patients of the treatment group. By subtracting the counterfactual value from the ROI for patients of the treatment group, the ROI attributable to the program may be identified.

FIG. 3 is a flowchart illustrating an example process 300 of using one or more machine learning models for calculating return on investment, according to some embodiments. Process 300 shall be described with reference to FIG. 1; however, process 300 is not limited to that example embodiment.

Process 300 may be executed on any computing device, such as, for example, the exemplary computer system described with reference to FIG. 4. Process 300 may be performed by processing logic that may comprise hardware (e.g., circuitry, dedicated logic, programmable logic, microcode, etc.), software (e.g., instructions executing on a processing device), or a combination thereof.

In some embodiments, one or more of the steps shown in FIG. 3 may be omitted, repeated, performed simultaneously, and/or performed in a different order than the order shown in FIG. 3. Accordingly, the scope of the invention should not be considered limited to the specific arrangement of steps shown in FIG. 3. The steps shown in FIG. 3 may be implemented as computer-readable instructions stored on computer-readable media, where, when the instructions are executed, cause a processor to perform the process of FIG. 3.

At 310, ROI engine 110 trains a base machine learning model. The base machine learning model may be trained to determine the ROI of a program. The base machine learning model may be machine learning model 118 of machine learning model 116. A base machine learning model may be configured as, but not limited to, an xgboost model, random forest model, or light GBM model. In some embodiments, the base machine learning model may be trained to predict a patient’s healthcare costs given training data. Training data may include, but is not limited to, (1) enrollment data; (2) claim data; (3) healthcare effectiveness data and information set (HEDIS) metrics; (4) adjusted clinical group risk scores; (5) custom metrics; (6) patient demographic data; and (7) patient medical history data. ROI engine 110 may train the base machine learning model on training data including individuals that did not participate in the program.

At 320, ROI engine 110 trains a global machine learning model. The global machine learning model may be machine learning model 118 of machine learning model 116. In some embodiments, the global machine learning model may be trained to simultaneously predict outcomes in scenarios both with program participation and without program participation. The global machine learning model may be trained to learn weights to apply to predictions from base machine learning models trained at 310. As noted above, ROI engine 110 may use ensemble learning where it combines the outputs from multiple base machine learning models (e.g., machine learning models 118). However, since the architecture of the base machine learning models may differ, the base machine learning models may emphasize certain features over others. For example, an xgboost model may emphasize a feature corresponding to recent health changes and a random forest model may emphasize a feature corresponding to age. Thus, taking the average of the base machine learning model predictions may produce an incorrect result because certain features may be overemphasized. As a result, the global machine learning model may weight the prediction of each base machine learning model to account for feature emphasis of the base machine learning models. In some embodiments, the global machine learning model may weight the prediction of each base machine learning model to account for feature emphasis of the base machine learning models in both the program participation and non-participation scenarios.

At 330, ROI engine 110 inputs data to a base machine learning model. The base machine learning model may be machine learning model 118 of machine learning module 116. The data input to the base machine learning model may be data of a patient that did participate in the program. Input data may include but is not limited to: (1) demographic and member information; (2) enrollment and eligibility data; (3) clinical and risk indicators; (4) claims and utilization metrics; and (5) quality and care management indicators.

Demographic and member information may be member identification and demographic characteristics including a member identifier, member age, member gender, member race, member ethnicity, and social determinants of health risk factors (e.g., social vulnerability index, economic risk, housing risk, minority risk, and transportation risk). Enrollment and eligibility data may be information about am ember’s coverage periods and enrollment status for various benefits.

Enrollment and eligibility data may include time period identifiers, end dates for different coverage types (e.g., medical coverage, dental coverage), duration of continuous enrollment, current enrollment status, and enrollment flags. Clinical and risk indicators may include disease conditions, risk scores, and clinical markers such as CMS condition flags (e.g., asthma, chronic obstructive pulmonary disease, chronic heart failure, and diabetes), episode risk group scores, special condition flags, a chronic condition count, an expanded diagnostic cluster (EDC) count, a prospective risk score, a retrospective risk score, and a medication adherence score. An EDC may be a classification used to group related may be used to group related medical conditions, symptoms, and diagnoses based on clinical similarity and treatment approaches.

Claim and utilization metrics may relate to healthcare service utilization and cost indicators. Here, metrics may include claim counts, service utilization (e.g., number of emergency room visits), financial metrics (e.g., allowed amount, paid amount), pharmacy utilization (e.g., prescriptions, specialty pharmacy prescriptions), and hospital metrics (e.g., readmissions rates, medicare-severity diagnosis-related group, and diagnosis-related group compliance level).

Quality and care management indicators may be used to determine healthcare quality and preventative care compliance. Quality and care management indicators may include HEDIS compliance indicators such as wellness visits, preventive screenings, chronic conditions, and care coordination (e.g., planned readmission, unplanned readmission). Quality and care management indicators may further include prevention service indicators, telehealth utilization, and avoidable emergency room visits,

At 340, the base machine learning model output is provided to the global machine learning model. The base machine learning model output may be an estimated cost had the patient not participated in the program. The global machine learning model may be configured to weight the output of the base machine learning model. Noted above, the global machine learning model may receive output from multiple base machine learning models. However, based on the different configurations of the base models, the global machine learning model may take a weighted average of the base model outputs to account for the differences in configurations. As a result, the weighted average may represent estimated healthcare costs of the patient had they not participated in the program. After determining a weighted average, ROI engine 110 may subtract the global machine learning model output from the patient’s actual costs, to determine the ROI of the program.

For example, ROI engine 110 may be utilized to determine the ROI of a weight loss program. In some embodiments, ROI engine 110 may train one or more base machine learning models on data of patients that did not participate in the weight loss program. ROI engine 110 may further train a global machine learning model to learn weights associated with each of the base machine learning models. ROI engine 110 may then input data of a patient that did participate in the weight loss program to determine an ROI value. The patient may previously have spent $1,000 in a period prior to beginning the weight loss program, and $800 in a period after finishing the weight loss program. The base machine learning models may receive, as input, the patient’s data and each determine an estimated cost (or savings) based on a similarity between the patient’s data and training data of individuals that did not participate in the weight loss program. The global machine learning model may weight the output of each base machine learning model to determine a final estimated cost. The final estimated cost may be, for example, $900. ROI engine 110 may take the difference between the patient’s actual cost after finishing the weight loss program, and the output of the global machine learning model to determine that the ROI attributable to the weight loss program is $100. Stated differently, although the patient saved $200 after completing the weight loss program, when compared to patients that did not participate in the weight loss program, ROI engine 110 estimated that only $100 of the savings is attributable to participating in the program.

Continuing with the above weight loss program example, in some embodiments, ROI engine 110 may train one or more base machine learning models to simultaneously predict outcomes in scenarios both with program participation and without program participation. ROI engine 110 may further train a global machine learning model to learn weights associated with each of the base machine learning models for both scenarios. ROI engine 110 may then input a patient’s data to determine a prospective ROI value by calculating the difference between the predicted costs in both scenarios. For instance, the machine learning models may predict that without the weight loss program, the patient would spend $1,000 in the upcoming period, while with program participation, they would spend $800. The base machine learning models would receive, as input, the patient’s data and each determine estimated costs for both scenarios. The global machine learning model would weight the output of each base machine learning model to determine final estimated costs for both paths. ROI engine 110 would then take the difference between the predicted costs with and without program participation to determine that the ROI attributable to the weight loss program is $200. This approach allows healthcare organizations to make data-driven decisions about program implementation based on predicted incremental value rather than retrospective analysis.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure is not intended to be limited by any of the above-described exemplary embodiments.

What is claimed is:

1. A computer-implemented method, the method comprising:
retrieving, from the one or more data stores, a first set of training data;
classifying training data within the first set of training data as belonging to one of a patient treatment group and a patient control group, wherein the patient treatment group includes data of patients participating in a program and the patient control group includes data of patients not participating in the program;
training a plurality of base machine learning models using a dual-training process by:
inputting the training data classified as belonging to the patient control group into each of the plurality of base machine learning models, wherein each of the plurality of base machine learning models output a plurality of counterfactual values associated with patients not participating in the program; and
inputting the training data classified as belonging to the patient treatment group into each of the plurality of base machine learning models, wherein each of the plurality of base machine learning models output a plurality of return on investment (ROI) predictions associated with patients participating in the program;
training a global machine learning model based on the plurality of counterfactual values and the plurality of ROI predictions output during the dual-training process;
receiving, from one of the one or more data stores, collected patient data for a period of time;
for each of the base machine learning models, generating a counterfactual value based on the collected patient data;
for each of the base machine learning models, generating a ROI prediction based on the collected patient data;
generating an attributable ROI based on inputting the generated counterfactual values and the generated ROI predictions into the global machine learning model, wherein the global machine learning model is pre-trained to combine outputs from the plurality of base machine learning models.

2. The computer-implemented method of claim 1, wherein the training data includes at least one of: (1) enrollment data; (2) claim data; (3) healthcare effectiveness data and information set (HEDIS) metrics; (4) adjusted clinical group risk scores; (5) custom metrics; (6) patient demographic data; and (7) patient medical history data.

3. The computer-implemented method of claim 1, wherein the plurality of base machine learning models include a XGBoost model, a Random Forest model, and a light gradient boosting machine (GBM) model.

4. The computer-implemented method of claim 3, wherein the dual-training process includes a plurality of hyperparameter sets, each hyperparameter set corresponding to a respective machine learning model of the plurality of base machine learning models, wherein the hyperparameter set for the XGBoost model includes one or more of a learning rate, a first maximum depth, and a number of estimators; the hyperparameter set for the Random Forest model includes one or more of a number of estimators, a second maximum depth, and a minimum number of samples per split; and the hyperparameter set for the light GBM model includes one or more regularization parameters.

5. The computer-implemented method of claim 1, wherein the global machine learning model is configured to weight each of the input ROI predictions and each of the input counterfactual values.

6. The computer-implemented method of claim 1, wherein each of the plurality of base machine learning models is configured to generate the counterfactual value and the ROI prediction based on the collected patient data by:
performing a first task to generate the counterfactual value and performing a second task to generate the ROI prediction, wherein the first task and second task are performed simultaneously without conflicting with each other.

7. The computer-implemented method of claim 1, further comprising:
normalizing the retrieved training data to account for differences in a patient population associated with the retrieved training data.

8. A system, comprising:
a memory; and
at least one processor coupled to the memory and configured to:
retrieve, from the one or more data stores, a first set of training data;
classify training data within the first set of training data as belonging to one of a patient treatment group and a patient control group, wherein the patient treatment group includes data of patients participating in a program and the patient control group includes data of patients not participating in the program;
train a plurality of base machine learning models using a dual-training process by:
input the training data classified as belonging to the patient control group into each of the plurality of base machine learning models, wherein each of the plurality of base machine learning models output a plurality of counterfactual values associated with patients not participating in the program; and
input the training data classified as belonging to the patient treatment group into each of the plurality of base machine learning models, wherein each of the plurality of base machine learning models output a plurality of return on investment (ROI) predictions associated with patients participating in the program;
train a global machine learning model based on the plurality of counterfactual values and the plurality of ROI predictions output during the dual-training process;
receive, from one of the one or more data stores, collected patient data for a period of time;
for each of the base machine learning models, generate a counterfactual value based on the collected patient data;
for each of the base machine learning models, generate a ROI prediction based on the collected patient data;
generate an attributable ROI based on inputting the generated counterfactual values and the generated ROI predictions into the global machine learning model, wherein the global machine learning model is pre-trained to combine outputs from the plurality of base machine learning models.

9. The system of claim 8, wherein the training data includes at least one of: (1) enrollment data; (2) claim data; (3) healthcare effectiveness data and information set (HEDIS) metrics; (4) adjusted clinical group risk scores; (5) custom metrics; (6) patient demographic data; and (7) patient medical history data.

10. The system of claim 8, wherein the plurality of base machine learning models include a XGBoost model, a Random Forest model, and a light gradient boosting machine (GBM) model.

11. The system of claim 10, wherein the dual-training process includes a plurality of hyperparameter sets, each hyperparameter set corresponding to a respective machine learning model of the plurality of base machine learning models, wherein the hyperparameter set for the XGBoost model includes one or more of a learning rate, a first maximum depth, and a number of estimators; the hyperparameter set for the Random Forest model includes one or more of a number of estimators, a second maximum depth, and a minimum number of samples per split; and the hyperparameter set for the light GBM model includes one or more regularization parameters.

12. The system of claim 8, wherein the global machine learning model is configured to weight each of the input ROI predictions and each of the input counterfactual values.

13. The system of claim 8, wherein each of the plurality of base machine learning models is configured to generate the counterfactual value and the ROI prediction based on the collected patient data by:
performing a first task to generate the counterfactual value and performing a second task to generate the ROI prediction, wherein the first task and second task are performed simultaneously without conflicting with each other.

14. The system of claim 8, the at least one processor further configured to:
normalize the retrieved training data to account for differences in a patient population associated with the retrieved training data.

15. A non-transitory computer-readable medium having instructions stored thereon that, when executed by at least one computing device, causes the at least one computing device to perform operations comprising:
retrieving, from the one or more data stores, a first set of training data;
classifying training data within the first set of training data as belonging to one of a patient treatment group and a patient control group, wherein the patient treatment group includes data of patients participating in a program and the patient control group includes data of patients not participating in the program;
training a plurality of base machine learning models using a dual-training process by:
inputting the training data classified as belonging to the patient control group into each of the plurality of base machine learning models, wherein each of the plurality of base machine learning models output a plurality of counterfactual values associated with patients not participating in the program; and
inputting the training data classified as belonging to the patient treatment group into each of the plurality of base machine learning models, wherein each of the plurality of base machine learning models output a plurality of return on investment (ROI) predictions associated with patients participating in the program;
training a global machine learning model based on the plurality of counterfactual values and the plurality of ROI predictions output during the dual-training process;
receiving, from one of the one or more data stores, collected patient data for a period of time;
for each of the base machine learning models, generating a counterfactual value based on the collected patient data;
for each of the base machine learning models, generating a ROI prediction based on the collected patient data;
generating an attributable ROI based on inputting the generated counterfactual values and the generated ROI predictions into the global machine learning model, wherein the global machine learning model is pre-trained to combine outputs from the plurality of base machine learning models.

16. The non-transitory computer-readable medium of claim 15, wherein the training data includes at least one of: (1) enrollment data; (2) claim data; (3) healthcare effectiveness data and information set (HEDIS) metrics; (4) adjusted clinical group risk scores; (5) custom metrics; (6) patient demographic data; and (7) patient medical history data.

17. The non-transitory computer-readable medium of claim 15, wherein the plurality of base machine learning models include a XGBoost model, a Random Forest model, and a light gradient boosting machine (GBM) model.

18. The non-transitory computer-readable medium of claim 15, wherein the dual-training process includes a plurality of hyperparameter sets, each hyperparameter set corresponding to a respective machine learning model of the plurality of base machine learning models, wherein the hyperparameter set for the XGBoost model includes one or more of a learning rate, a first maximum depth, and a number of estimators; the hyperparameter set for the Random Forest model includes one or more of a number of estimators, a second maximum depth, and a minimum number of samples per split; and the hyperparameter set for the light GBM model includes one or more regularization parameters.

19. The non-transitory computer-readable medium of claim 15, wherein the global machine learning model is configured to weight each of the input ROI predictions and each of the input counterfactual values.

20. The non-transitory computer-readable medium of claim 15, the operations further comprising:
normalizing the retrieved training data to account for differences in a patient population associated with the retrieved training data.
